(19) United States
(12) Patent Application Publication
(10) Pub. No.: US 2012/0060134 A1
(43) Pub. Date: Mar. 8, 2012

(54) Wiring Design Support Apparatus and Wiring Design Support Method

(76) Inventors: Akihisa Shimizu, Tokyo (JP); Takahiro Sugai, Kokubunji-shi (JP)

(21) Appl. No.: 13/094,680

(22) Filed: Apr. 26, 2011

(30) Foreign Application Priority Data
Sep. 6, 2010 (JP) 2010-199382

(51) Int. Cl. G06F 17/50

(52) U.S. Cl. 716/111; 716/110

(57) ABSTRACT

According to one embodiment, a wiring design support apparatus comprises a display, a drawing module, and a data creation module. The display is configured to display a three-dimensional object. The drawing module is configured to draw a line connecting two points on a surface of the three-dimensional object displayed by the display. The data creation module is configured to create first three-dimensional data indicating a wiring based on the line drawn by the drawing module.

### CROSS-REFERENCE TO RELATED APPLICATIONS

This application is based upon and claims the benefit of priority from Japanese Patent Application No. 2010-199382, filed Sep. 6, 2010; the entire contents of which are incorporated herein by reference.

### FIELD

Embodiments described herein relate generally to a wiring design support apparatus and wiring design support method which support design of three-dimensional wiring.

### BACKGROUND

A two-dimensional computer-aided design (CAD) system is used for design of a system substrate. In the two-dimensional CAD system, an image of the system substrate is displayed on a screen, and then the designer manually designates a starting point, end point, and node (point at which wiring bends), whereby a first wiring pattern is formed. When a plurality of wirings are arranged in parallel with each other, second and subsequent wiring patterns can be automatically formed on the basis of the already formed wiring pattern. The formed wiring patterns are expressed by two-dimensional shape data having a two-dimensional parameter of width and length.

In recent years, the system substrate tends to become thinner in order that the degree of integration may be enhanced and, when the system substrate is subjected to deflection or bending, the system substrate is easy to fail. Thus, consideration is now given to further forming part of wiring not on the system substrate but in the housing. By moving part of the wiring from the system substrate to the housing, it is possible to prevent a failure from occurring. Furthermore, the housing has an advantage that the wiring can be formed easier, and cost is low.

In recent years, regarding the information processing equipment, reduction in weight and thickness is advancing, and hence spatial room for arrangement of harness components used to electrically connect the system substrate and electronic components to each other has become small. Thus, by using a housing wiring in place of a harness, it is possible to make the harness unnecessary, and save the cost of the harness itself.

Design of the housing is carried out by using a three-dimensional CAD system. In the three-dimensional CAD system, a three-dimensional size (length, width, and thickness) of an object is input thereto, and three-dimensional shape data of the object is created. However, the three-dimensional CAD system is an apparatus configured only to form the shape of the object, and has no function of forming a wiring pattern, and creating the three-dimensional shape data thereof.

On the other hand, the two-dimensional CAD system is configured to form a wiring pattern only for a two-dimensional object, such as the system substrate. When components or mounted parts desired to be connected to each other are designated by placing a straight line or a broken line between them, a two-dimensional wiring pattern having a predetermined width is drawn. The two-dimensional CAD system has no concept of three dimensions, and hence cannot create three-dimensional shape data expressing a wiring pattern to be formed on the housing.

Accordingly, in order to form a wiring pattern on the housing, it is necessary to manually input a three-dimensional size of a wiring pattern one by one by using a three-dimensional CAD system, this being work requiring much time and labor.

There has been the problem that the conventional wiring design support apparatus and wiring design support method cannot form the three-dimensional shape data expressing a three-dimensional wiring pattern in a short time and easily.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram showing an example of the configuration of a wiring design support apparatus of an embodiment.

FIG. 2 is an exemplary flowchart showing an example of a wiring design support method of the embodiment.

FIG. 3 is an exemplary view showing a display example in an operation in the wiring design support method of the embodiment.

FIG. 4 is an exemplary view showing a display example in another operation in the wiring design support method of the embodiment.

FIG. 5 is an exemplary view showing a display example in another operation in the wiring design support method of the embodiment.

FIG. 6 is an exemplary view showing a display example in another operation in the wiring design support method of the embodiment.

FIG. 7 is an exemplary view showing a display example in another operation in the wiring design support method of the embodiment.

FIG. 8 is an exemplary view showing a display example in another operation in the wiring design support method of the embodiment.

FIG. 9 is an exemplary view showing a display example in another operation in the wiring design support method of the embodiment.

### DETAILED DESCRIPTION

Various embodiments will be described hereinafter with reference to the accompanying drawings. In general, according to one embodiment, a wiring design support apparatus comprises a display, a drawing module, and a data creation module. The display is configured to display a three-dimensional object. The drawing module is configured to draw a line connecting two points on a surface of the three-dimensional object displayed by the display. The data creation module is configured to create first three-dimensional data indicating a wiring based on the line drawn by the drawing module.

Hereinafter, an embodiment will be described with reference to the drawings.

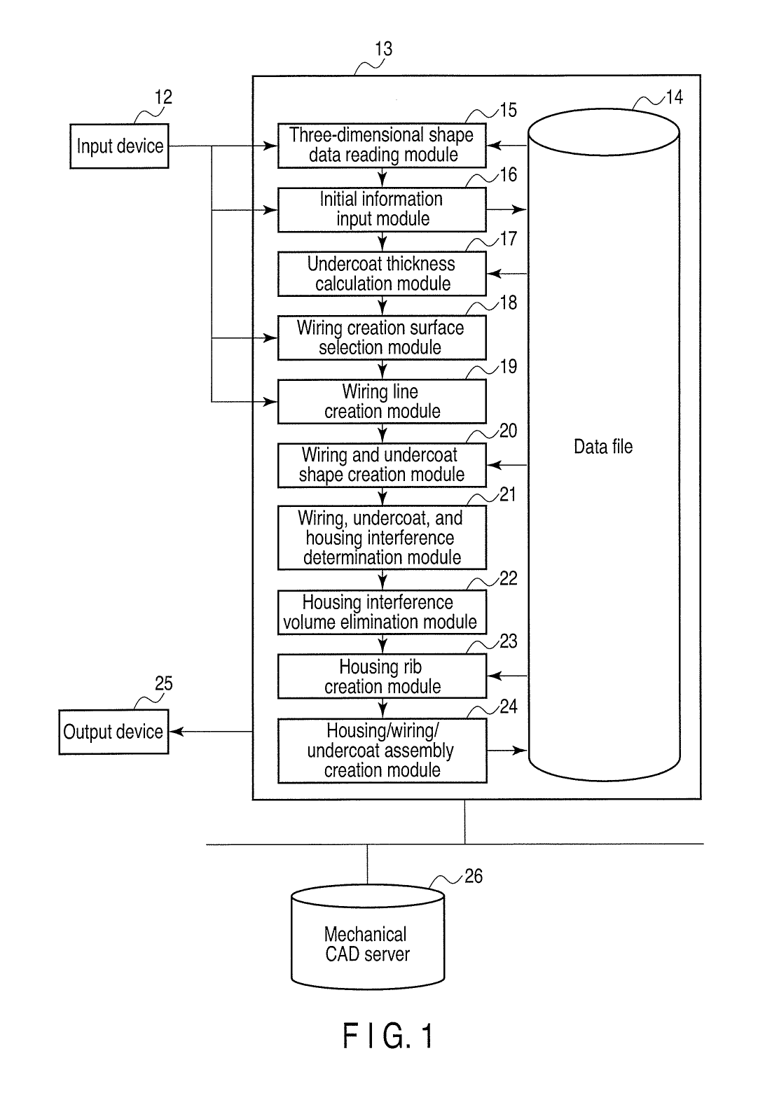

FIG. 1 is a block diagram of a wiring design support apparatus. The apparatus includes an input device 12 such a keyboard, mouse or the like, a processor 13, and an output device 25 such as an LCD display or the like. The processor 13 is connected to a mechanical CAD server 26 through a network. The mechanical CAD server 26 stores therein three-dimensional shape data of a housing designed by a conventional three-dimensional CAD system. The three-dimensional shape data may be prepared by the designer himself or herself and stored in the mechanical CAD server 26 or may be prepared by another person and received from the person to be stored in the mechanical CAD server 26.

The processor 13 includes a data file 14, three-dimensional shape data reading module 15, initial information input module 16, undercoat thickness calculation module 17, wiring creation surface selection module 18, wiring line creation module 19, wiring and undercoat shape creation module 20, wiring, undercoat, and housing interference determination module 21, housing interference volume elimination module 22, housing rib creation module 23, and housing/wiring/undercoat assembly creation module 24. The input device 12 is connected to the three-dimensional shape data reading module 15, initial information input module 16, wiring creation surface selection module 18, and wiring line creation module 19.

The three-dimensional shape data reading module 15 reads three-dimensional shape data from the mechanical CAD server 26 in accordance with an instruction from the designer given thereto through the input device 12. The read three-dimensional shape data is stored in the data file 14.

The initial information input module 16 stores initial information (width/height of a rib and wiring thickness) input from the designer through the input device 12 in the data file 14. Although a method of forming the wiring in the housing can be considered in various ways, it is assumed here that a linear member (i.e., a semicolumnar member) formed of a conductor (e.g., copper) having a cross section of a certain shape (e.g., a semicircle) is embedded in the surface of the housing as the wiring. The cross-sectional shape is not limited to the semicircle, and may also be a circle, rectangle, and the like. When the cross-sectional shape is a semicircle or circle, the cross-sectional shape can be specified by designating the wiring thickness. In order to embed the wiring in the surface of the housing, it is necessary to chisel the surface of the housing, and there is the possibility of the strength of the housing being lowered correspondingly. In such a case, in order to compensate for the lowering of the strength, ribs are formed along both sides of the wiring. Here, it is assumed that the rib is a linear member having a rectangular cross section. Accordingly, the cross-sectional shape of the rib can be specified by designating the width and height.

The undercoat thickness calculation module 17 calculates the thickness of an undercoat layer based on the wiring thickness stored in the data file 14. The undercoat layer is an electrically conductive layer arranged between the wiring and housing, and configured to adjust the impedance in such a manner that the characteristic impedance of the wiring becomes the desired impedance, and has a shape of a part of a cylinder conforming to the underside surface of the wiring. The characteristic impedance of the wiring corresponds to the thickness thereof, and hence the thickness of the undercoat layer used to adjust the characteristic impedance also corresponds to the thickness of the wiring. The calculated data is stored in the data file 14. The wiring creation surface selection module 18 designates the part of the surface of the housing in which the wiring pattern is to be created in accordance with an instruction given thereto from the designer through the input device 12.

The wiring line creation module 19 creates a reference line of the wiring in accordance with an instruction given thereto from the designer through the input device 12 on the part of the surface of the housing designated by the wiring creation surface selection module 18. The wiring pattern is created as a pattern of a semicircular column having the reference line of the wiring as a centerline thereof.

The wiring and undercoat shape creation module 20 creates, around the reference line of the wiring created by the wiring line creation module 19, a semicolumnar three-dimensional wiring shape (three-dimensional data) having a thickness stored in the data file 14, and semicylindrical three-dimensional undercoat shape (three-dimensional data) having a thickness stored in the data file 14. The created three-dimensional data items are stored in the data file 14.

The wiring, undercoat, and housing interference determination module 21 determines whether or not the assembly shape (semicolumnar shape) of the wiring/undercoat created by the wiring and undercoat shape creation module 20 can be contained in the housing. The wiring is to be embedded in the groove provided in the housing surface, and hence, depending on the shape of the wiring, the wiring breaks through the back or side surface of the housing in some cases. Accordingly, it is determined whether or not the wiring breaks through the back or side surface of the housing.

The housing interference volume elimination module 22 eliminates the semicolumnar area corresponding to the assembly shape of the wiring/undercoat from the housing to correct the housing data.

The housing rib creation module 23 creates shapes of the ribs for reinforcement having the width/height stored in the data file 14 along both sides of the wiring pattern to correct the housing data. Although the cross section of the rib is assumed to be rectangular, the cross section may have an arbitrary shape. Further, it is not always necessary to provide the ribs on both sides of the wiring, and a rib may be provided only on one side. Furthermore, it is not always necessary to provide ribs or a rib continuously along the wiring and, if the strength is sufficient, the ribs or the rib may also be provided intermittently.

The housing/wiring/undercoat assembly creation module 24 creates an assembly including the housing/wiring/undercoat, and stores the three-dimensional data of the assembly in the data file 14.

An output device 25 provides a user interface of each of various stages of the above-mentioned processing.

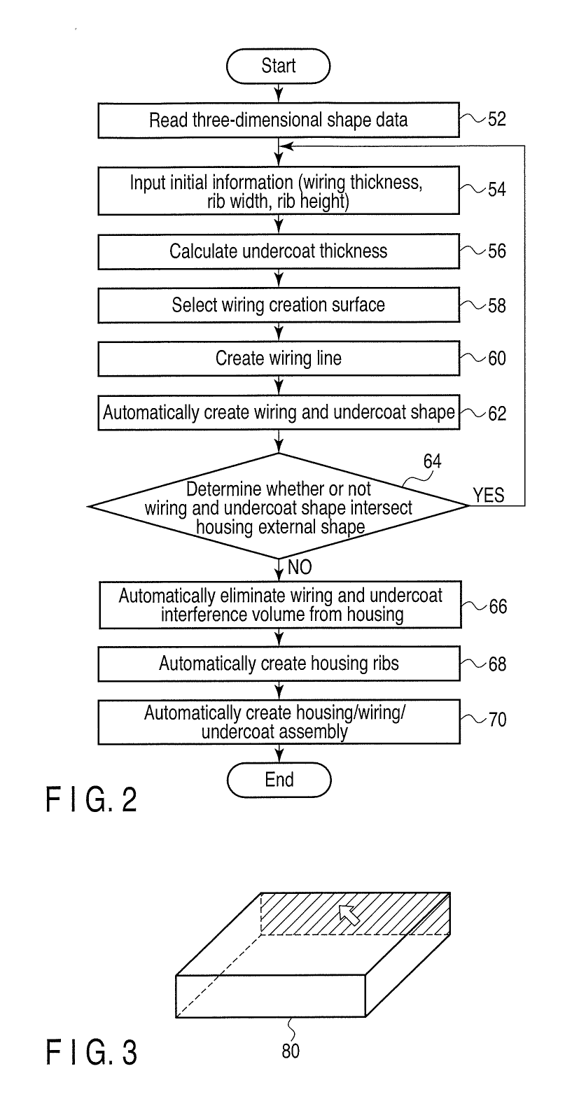

FIG. 2 is a flowchart showing an operation of the wiring design support apparatus of FIG. 1. The operation will be described below with reference to FIG. 2.

The display apparatus 25 displays, on the initial screen, a list of three-dimensional shape data items of the housing stored in the mechanical CAD server 26, and makes the designer select a housing for which wiring is to be carried out. It should be noted that the three-dimensional shape data of the housing is not limited to data created in advance and stored in the mechanical CAD server 26, it is also possible to utilize data (data in the three-dimensional CAD system, and not yet stored in the mechanical CAD server 26) created by the designer by himself or herself by using a three-dimensional CAD system (not shown).

When a housing for which wiring is to be carried out is selected by the designer from the list by using the input device 12, the three-dimensional shape data reading module 15 reads the three-dimensional shape data of the selected housing from the mechanical CAD server 26, and stores the read data in the data file 14 as shown in block 52. After this, the mechanical CAD server 26 may be disconnected from the processor 13. The display device 25 displays the three-dimensional shape of the housing 80 stored in the data file 14 as shown in FIG. 3. Here, it is assumed that the housing is a housing of a notebook personal computer, and has a flat parallelepipedic shape with six surfaces.

In block 54, the designer inputs the thickness of the wiring, and width/height of the rib as the initial information by using the input device 12. However, as the initial information, a default value determined in advance may be used or the initial information may be appropriately changed from the default value. The default value is determined for each product or for each type of the housing. The input numerical value is stored in the data file 14 by the initial information input module 16. When the ribs are not necessary, it is sufficient if the value of the width/height is set to zero.

In block 56, the undercoat thickness calculation module 17 calculates the thickness (thickness of the semicylinder) of the undercoat layer in accordance with the wiring thickness stored in the data file 14, and stores the calculated thickness data in the data file 14.

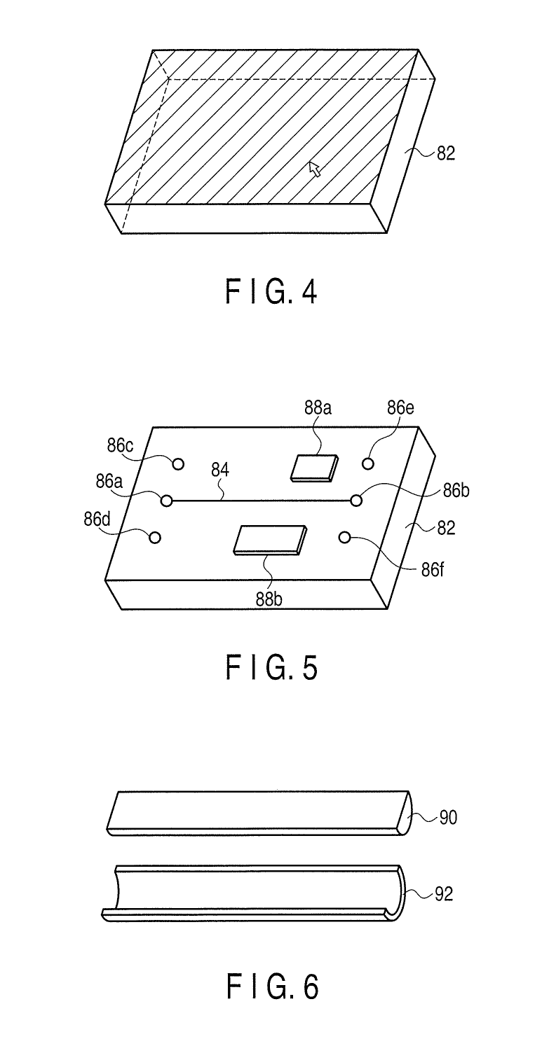

Next, the designer designates a surface in which the wiring pattern is to be formed in the three-dimensional shape of the housing 80 displayed as shown in FIG. 3 (block 58). By pointing at and clicking on one of six surfaces of the housing, a wiring formation surface is designated. FIG. 3 shows a case where the inner part is designated as the a wiring formation surface. When the wiring formation surface is designated, the wiring creation surface selection module 18 displays only the designated wiring formation surface 82 on the screen of the display device 25 as shown in FIG. 4. Here, the wiring formation surface 82 is a part having six surfaces and the wiring is actually formed is one of the surfaces. Accordingly, the main surface in which the wiring is to be formed is further designated from the wiring formation surface 82. Here, it is assumed that the surface of the wiring formation surface 82 on the nearest side (hatched surface in FIG. 4) is designated as the wiring formation main surface.

When the wiring formation main surface is designated, the wiring creation surface selection module 18 displays a shape image of the housing surface on the wiring formation main surface as shown in FIG. 5. On the main surface, terminals 86a, 86b, 86c, 86d, 86e, and 86f electrically connected to a system substrate (not shown), projections 88a and 88b peculiar to the housing, and the like are present.

The designer designates a point at which the designer wants to draw wiring on the display screen. Here, it is assumed that the wiring includes a straight line. When a starting point (terminal 86a), and end point (terminal 86b) are designated, the wiring line creation module 19 draws a reference line 84 of the wiring in block 60 as shown in FIG. 5. It should be noted that there are the projections 88a and 88b between the terminals 86c and 86e or between the terminals 86d and 86f, if a reference line is to be drawn between the terminals 86c and 86e or between the terminals 86d and 86f, the reference line is drawn as a zigzag line.

In block 62, the wiring and undercoat shape creation module 20 creates a semicolumnar three-dimensional wiring shape (three-dimensional data) 90 having the reference line 84 of the wiring as a centerline thereof, and having the thickness stored in the data file 14, and semicylindrical three-dimensional undercoat shape (three-dimensional data) 92 having the thickness stored in the data file 14, as shown in FIG. 6. The length of each of the three-dimensional wiring shape and three-dimensional undercoat shape corresponds to the length of the reference line 84.

In block 64, the wiring, undercoat, and housing interference determination module 21 determines whether or not the assembly shape (semicolumnar shape or semicylindrical shape) of the wiring/undercoat created in block 62 by the wiring and undercoat shape creation module 20 intersects (uncontainable in the housing) the external surface of the housing. The case where the assembly shape intersects the external surface of the housing implies a case where the assembly shape cannot be contained in the housing, and it can be determined that the initial information is not appropriate. Accordingly, when the determination result of block 64 is “yes”, the processing returns to block 54 to carry out correction of the initial information, and the above-mentioned operations (blocks 54 to 64) are repeated.

When the determination result of block 64 is “no”, the assembly shape of the wiring/undercoat can be contained in the housing, and hence the flow advances to the next processing.

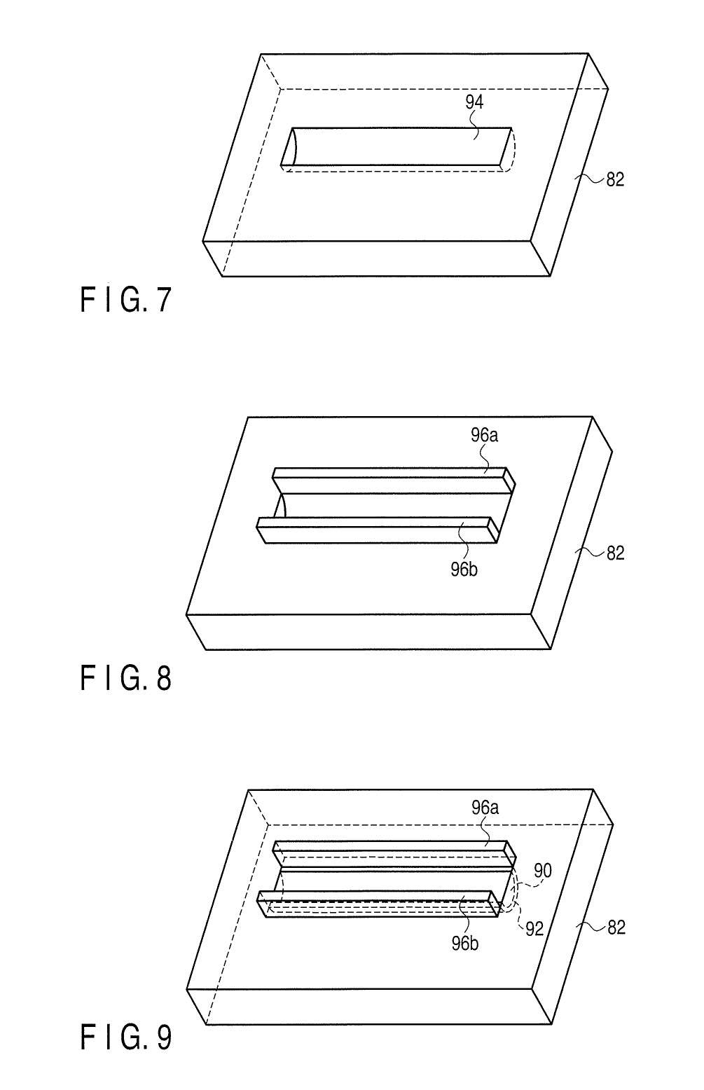

In block 66, the housing interference volume elimination module 22 eliminates the assembly shape 94 of the wiring/undercoat from the housing as shown in FIG. 7.

In block 68, the housing rib creation module 23 creates rib shapes 96a and 96b each having the width/height input in block 54 and stored in the data file 14 along both sides of the assembly shape 94 of the wiring/undercoat in the housing as shown in FIG. 8.

In block 70, the housing/wiring/undercoat assembly creation module 24 creates three-dimensional data of the assembly formed of the housing 82, wiring 90, undercoat 92, ribs 96a and 96b, and stores the created data in the data file 14. The final three-dimensional data stored in the data file 14 may be supplied to a simulator (not shown) through a network to simulate the strength of the housing from which the assembly shape 94 is eliminated.

As has been described above, according to the first embodiment, only by drawing a reference line serving as a centerline of the wiring on the display screen of the three-dimensional object, a wiring pattern of a three-dimensional shape having a thickness input in advance is automatically formed. Thereby, it is possible to easily carry out formation of a wiring pattern in the housing in a short time. When a three-dimensional wiring shape is created by utilizing a conventional three-dimensional CAD system, it is necessary to input the three-dimensional measurements one by one, thereby requiring much labor and time. Conversely, according to this embodiment, only by drawing a reference line, thereafter a three-dimensional shape is automatically created, and hence the shape creation man-hour is reduced.

Further, according to this embodiment, it is also possible to automatically create a three-dimensional shape of an undercoat layer having an appropriate thickness for adjusting the characteristic impedance. Furthermore, when the housing surface is chiseled to embed the wiring in the surface, if there is the possibility of the strength of the housing being lowered, it is also possible to automatically create three-dimensional shapes of ribs for reinforcement.

When wiring is to be formed in the housing, a load is applied to the housing by pressing the housing or by applying vibration to the housing, and hence it is necessary to verify the formation of the wiring from the point of view of strength. However, according to this embodiment, three-dimensional data of a housing in which the wiring, undercoat layer, and ribs are formed is created, and hence it is possible to send the three-dimensional data to a simulator, and evaluate the design of the housing by applying a load of bending or torsion to the housing on the simulator.

In the embodiment described above, although the wiring is embedded in the surface by chiseling the surface of the housing, the arrangement of the wiring is not limited to this, and the wiring may be formed on the surface of the housing in a protruding manner. In this case, the housing is not chiseled, further the strength of the housing is not lowered from the designed value, and hence it is not always necessary to provide the ribs for reinforcement. It should be noted that even in this case, the undercoat layer for impedance adjustment is provided as the need arises.

When the size of the assembly shape of the wiring/undercoat layer exceeds the size (thickness and width) of the housing, although the processing returns to block 54 to carry out manual input of correction of the initial information, the initial information may also be automatically corrected by calculating a thickness of the wiring and/or width/height of the rib that enable the assembly to be contained in the housing based on the three-dimensional shape data of the housing.

Although an example in which no components or no mounted parts are provided in the housing has been described above, components or mounted parts may be provided also in the housing, and the components and parts may be connected to each other by the wiring in or on the surface of the housing. For example, an antenna is directly formed on a housing of a portable wireless device in an integrating manner in some cases. In this case, a conductive paste is printed on the surface of a resin housing, and the paste is plated with copper or the like, whereby an electrical wiring is formed. Further, the object of wiring formation is not limited to the housing, and the object may be a sheet metal member provided inside the housing.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A wiring design support apparatus comprising:
a display configured to display a three-dimensional object;
a drawing module configured to draw a line on a surface of the three-dimensional object displayed by the display; and
a data creation module configured to create three-dimensional data of a wiring based on the line drawn by the drawing module and three-dimensional data indicating a layer under the wiring, the layer comprising a predetermined characteristic impedance.

2. A wiring design support apparatus comprising:
a display configured to display a three-dimensional object including a surface on which a wiring is to be formed;
a drawing module configured to draw a line connecting two points on the surface of the three-dimensional object displayed by the display; and
a data creation module configured to create a first three-dimensional data indicating a third-dimensional shape of a wiring defined by the line drawn by the drawing module and a second three-dimensional data indicating an undercoat layer between the wiring and the layer of the object upon drawing of the line by the drawing module, the undercoat layer comprising a predetermined characteristic impedance.

3. The wiring design support apparatus of claim 2, wherein the characteristic impedance of the undercoat layer comprises a value for adjusting a characteristic impedance of the wiring.

4. A wiring design support apparatus comprising:
a display configured to display a three-dimensional object including a surface on which a wiring is to be formed;
a drawing module configured to draw a line connecting two points on the surface of the three-dimensional object displayed by the display; and
a data creation module configured to create a first three-dimensional data indicating a third three-dimensional shape of a wiring defined by the line drawn by the drawing module and a third three-dimensional data indicating a groove for housing the wiring and the undercoat layer, the groove being in the surface of the three-dimensional object displayed by the display.

5. The wiring design support apparatus of claim 4, further comprising:
an input module configured to input data indicating a shape of the wiring; and
a correction module configured to determine whether or not the groove indicated by the third three-dimensional data is within the three-dimensional object and to change the data input by the input module when it is determined that the grove is not within the three-dimensional object.

6. The wiring design support apparatus of claim 4, wherein the data creation module is configured to create a fourth three-dimensional data indicating a rib to be formed around the wiring and on the surface of the three-dimensional object.

7. (canceled)

8. A wiring design support method comprising:
displaying, by a display device, a three-dimensional object including a surface on which a wiring is to be formed;
drawing, by a wiring line drawing processor, a line connecting two points on the surface of the displayed three-dimensional object;
creating, by a three-dimensional data creation processor, a first three-dimensional data indicating a three-dimensional shape of a wiring defined by the drawn line; and
creating a second three-dimensional data indicating an undercoat layer between the wiring and the layer of the object upon drawing of the line, the undercoat layer comprising a predetermined characteristic impedance.

9. The wiring design support method of claim 8, wherein the characteristic impedance of the undercoat layer comprises a value for adjusting a characteristic impedance of the wiring.

10. A wiring design support method comprising:
displaying, by a display device, a three-dimensional object including a surface on which a wiring is to be formed;
drawing, by a wiring line drawing processor, a line connecting two points on the surface of the displayed three-dimensional object; and
creating, by a three-dimensional data creation processor, a first three-dimensional data indicating a three-dimensional shape of a wiring defined by the drawn line, and a
third three-dimensional data indicating a groove for housing the wiring and the undercoat layer, the groove being in the surface of the displayed three-dimensional object.

11. The wiring design support method of claim 10, further comprising:
inputting, by an input device, data indicating a shape of the wiring;
determining, by an interference processor, whether or not the groove indicated by the third three-dimensional data is within the three-dimensional object; and
changing the input data when it is determined that the grove is within the three-dimensional object.

12. The wiring design support method of claim 10, further comprising:
creating fourth three-dimensional data indicating a rib to be formed around the wiring and on the surface of the three-dimensional object displayed by the display device.
